(19) United States
(12) Patent Application Publication
(10) Pub. No.: US 2018/0040881 A1
(43) Pub. Date: Feb. 8, 2018

(54) NON-AQUEOUS ELECTROLYTE SECONDARY BATTERY

(71) Applicant: SANYO Electric Co., Ltd., Daito-shi, Osaka (JP)

(72) Inventors: Koichi Kusagawa, Osaka (JP); Kazuhiro Hasegawa, Hyogo (JP); Akira Nagasaki, Osaka (JP)

(73) Assignee: SANYO Electric Co., Ltd., Daito-shi, Osaka (JP)

(21) Appl. No.: 15/554,076

(22) PCT Filed: Feb. 22, 2016
(86) PCT No.: PCT/JP2016/000922

§ 371 Date: Aug. 28, 2017

(30) Foreign Application Priority Data
Mar. 13, 2015 (JP) 2015-050951

(51) Int. Cl. H01M 4/36; H01M 10/0525; H01M 4/587; H01M 4/131; H01M 4/48; H01M 4/485; H01M 10/0587; H01M 4/133

(52) U.S. Cl. CPC H01M 4/364; H01M 10/0587; H01M 10/0525; H01M 4/133; H01M 4/131; H01M 4/366; H01M 4/483; H01M 4/485; H01M 4/587; H01M 2220/20; H01M 2220/30

(57) ABSTRACT

A non-aqueous electrolyte secondary battery in an aspect of the present invention includes an electrode body formed by winding a positive electrode plate and a negative electrode plate with a separator interposed therebetween; a non-aqueous electrolyte; an outer can that houses the electrode body and the non-aqueous electrolyte; and a sealing body that seals an opening of the outer can. The negative electrode plate has a negative electrode mixture layer formed on a negative electrode current collector. The negative electrode mixture layer contains a silicon material and graphite as negative electrode active materials. The negative electrode plate has, at its winding start end, a first negative electrode current collector exposed portion to which a negative electrode tab is connected. The negative electrode plate has, at its winding finish end, a second negative electrode current collector exposed portion in contact with an inner wall surface of the outer can.

### TECHNICAL FIELD

The present invention relates to a non-aqueous electrolyte secondary battery having a high capacity and a good load characteristic.

### BACKGROUND ART

Recently, non-aqueous electrolyte secondary batteries have widely been used as power supplies for portable electronic devices, such as smart phones, tablet computers, laptop computers, and portable music players. The range of applications of non-aqueous electrolyte secondary batteries has expanded to now include, for example, power tools, electric power-assisted bicycles, and electric vehicles. This expansion has created a need for non-aqueous electrolyte secondary batteries that have a higher capacity and output more power.

Examples of negative electrode active materials mainly used in non-aqueous electrolyte secondary batteries include carbon materials such as graphite. Carbon materials can reduce the dendritic growth of lithium during charging while having a discharge potential similar to that of lithium. Because of these properties, the use of carbon materials as negative electrode active materials enables the production of non-aqueous electrolyte secondary batteries having a high level of safety. Graphite can intercalate lithium ions until the composition reaches LiC₆, and the theoretical capacity of LiC₆ is 372 mAh/g.

However, carbon materials that are currently used have already exhibited a capacity close to the theoretical capacity, and it is difficult to improve the capacity of non-aqueous electrolyte secondary batteries by modifying negative electrode active materials. Silicon materials, such as silicon and silicon oxide, having a higher capacity than carbon materials have recently attracted more attention as negative electrode active materials of non-aqueous electrolyte secondary batteries. For example, silicon can intercalate lithium ions until the composition reaches Li_{4.4}Si, and the theoretical capacity of Li_{4.4}Si is 4200 mAh/g. Therefore, the use of silicon materials as negative electrode active materials can improve the capacity of non-aqueous electrolyte secondary batteries.

Like carbon materials, silicon materials can reduce the dendritic growth of lithium during charging. However, silicon materials undergo larger expansion and shrinkage with charging and discharging than carbon materials. These properties of silicon materials cause, for example, negative electrode active materials to be reduced in particle size and/or to be separated from an electrically conductive network, which creates a problem of cycle characteristics of silicon materials inferior to those of carbon materials.

Patent Literature 1 discloses a non-aqueous electrolyte secondary battery having a negative electrode mixture layer containing, as negative electrode active materials, graphite and a material containing Si and O as constituent elements, and a positive electrode mixture layer containing, as a positive electrode active material, a lithium-transition metal composite oxide containing Ni, Mn, or other elements as an essential constituent element. It has been reported that a non-aqueous electrolyte secondary battery having a high capacity and good battery characteristics is obtained by controlling, in a predetermined range, the proportion of the material containing Si and O as constituent elements.

To improve the output characteristic of non-aqueous electrolyte secondary batteries, Patent Literature 2 discloses that a negative electrode tab is connected to each negative electrode active material-non-coated region formed at each end of the negative electrode plate of a non-aqueous electrolyte secondary battery.

Patent Literature 3 discloses a non-aqueous electrolyte secondary battery in which the negative electrode current collector on the outermost surface of the electrode body is in contact with the inner wall surface of the battery can with an electrically conductive elastic member interposed therebetween in order to minimize extra space in the battery can. Patent Literature 3 also discloses that a recess is formed on the side surface of the battery can in order to make contact between the negative electrode current collector on the outermost surface of the electrode body and the inner wall surface of the battery can.

### CITATION LIST

### Patent Literature

PTL 1: Japanese Published Unexamined Patent Application No. 2010-212228
PTL 2: Japanese Published Unexamined Patent Application No. 2001-110453
PTL 3: Japanese Published Unexamined Patent Application No. 2000-3722

### SUMMARY OF INVENTION

### Technical Problem

As disclosed in Patent Literature 2, a method of connecting a negative electrode tab to each end of the negative electrode plate is effective in improving the load characteristics of non-aqueous electrolyte secondary batteries. However, the studies by the inventors of the present invention have revealed that the electrode body is subject to deformation when a silicon material, such as silicon or silicon oxide, which undergoes large changes in volume during charging, is used as a negative electrode active material in the non-aqueous electrolyte secondary battery in which a negative electrode tab is connected to each end of the negative electrode plate.

When a plurality of negative electrode tabs are connected to the negative electrode plate, members that do not contributes to charging and discharging occupy some space in the battery, which results in a failure to improve the capacity of the battery.

The technique described in Patent Literature 3 does not require use of negative electrode tabs. To ensure electrical connection between the negative electrode current collector and the outer can, it is necessary to interpose an electrically conductive elastic member between the negative electrode plate and the outer can or to provide an annular groove on the side surface of the outer can. With the technique described in Patent Literature 3, it is difficult to improve both the capacity and the load characteristic of non-aqueous electrolyte secondary batteries.

In light of the aforementioned circumstances, the present invention is directed to a non-aqueous electrolyte secondary battery in which a silicon material and graphite are used as negative electrode active materials and which has a high capacity and a good load characteristic.

### Solution to Problem

To solve the aforementioned issues, a non-aqueous electrolyte secondary battery in an aspect of the present invention includes an electrode body formed by winding a positive electrode plate and a negative electrode plate with a separator interposed therebetween; a non-aqueous electrolyte; an outer can that houses the electrode body and the non-aqueous electrolyte; and a sealing body that seals an opening of the outer can. The negative electrode plate has a negative electrode mixture layer formed on a negative electrode current collector. The negative electrode mixture layer contains a silicon material and graphite as negative electrode active materials. The negative electrode plate has, at its winding start end, a first negative electrode current collector exposed portion to which a negative electrode tab is connected. The negative electrode plate has, at its winding finish end, a second negative electrode current collector exposed portion in contact with an inner wall surface of the outer can.

### Advantageous Effects of Invention

According to an aspect of the present invention, a non-aqueous electrolyte secondary battery having a high capacity and a good load characteristic can be provided.

### BRIEF DESCRIPTION OF DRAWINGS

FIG. 1 is a cross-sectional perspective view of a non-aqueous electrolyte secondary battery in Examples.

FIG. 2 is a plan view of a negative electrode plate in Examples.

FIG. 3 is a plan view of a positive electrode plate in Examples.

FIG. 4 is a perspective view of an electrode body in Examples.

FIG. 5 is a plan view of a negative electrode plate in Comparative Example 2 and Comparative Example 3.

FIG. 6 is a perspective view of an electrode body in Comparative Example 2 and Comparative Example 3.

### DESCRIPTION OF EMBODIMENTS

The embodiments of the present invention will be described by way of Examples and Comparative Examples. The present invention is not limited to the following embodiments. Changes and modifications can be appropriately carried out without departing from the scope of the present invention.

### EXAMPLES

### Example 1

(Production of Negative Electrode Active Material)

By chemical vacuum deposition (CVD) where silicon oxide having a composition of SiO (corresponding to general formula SiOₓ where x=1) was heated in an argon atmosphere containing a hydrocarbon gas so that the hydrocarbon gas was thermally decomposed, the surface of SiO was coated with carbon. The amount of carbon that covered the surface of SiO was 10% by mass relative to the mass of SiO. The SiO particles coated with carbon were subjected to disproportionation in an argon atmosphere at 1000° C. to form a fine Si phase and a fine SiO₂ phase in the SiO particles. The obtained particles were classified so as to obtain a predetermined particle size, providing SiO as a silicon material. This SiO and graphite were mixed such that the mass of SiO was 4% by mass relative to the total mass of SiO and graphite, whereby a negative electrode active material was produced.

(Production of Negative Electrode Plate)

The following materials were mixed: 97 parts by mass a negative electrode active material; 1.5 parts by mass carboxymethyl cellulose (CMC), which was a thickener; and 1.5 parts by mass styrene-butadiene rubber (SBR), which was a binder. This mixture was placed in water serving as a dispersion medium, and the dispersion was kneaded to prepare a negative electrode mixture slurry. The negative electrode mixture slurry was applied by a doctor blade method to both sides of a negative electrode current collector made of copper and having a thickness of 8 μm. The negative electrode mixture slurry was dried to form a negative electrode mixture layer 23. In this process, a first negative electrode current collector exposed portion 24a and a second negative electrode current collector exposed portion 24b were provided at positions corresponding to the ends of the completed negative electrode plate 21. In the portions 24a and 24b, the negative electrode mixture layer 23 was not formed on either side of the negative electrode plate 21. This negative electrode mixture layer 23 was compressed with a roller and the compressed electrode plate was cut in a predetermined size. Finally, a negative electrode tab 22a made of nickel was connected to the first negative electrode current collector exposed portion 24a to produce a negative electrode plate 21 illustrated in FIG. 2.

(Production of Positive Electrode Active Material)

A nickel composite oxide represented by formula Ni_{0.82}Co_{0.15}Al_{0.03}O₂ was mixed with lithium hydroxide such that the ratio of the number of moles of a lithium element to the total number of moles of metal elements in the nickel composite oxide was 1.025. This mixture was fired in an oxygen atmosphere at 750° C. for 18 hours to produce a lithium-nickel composite oxide represented by LiNi_{0.82}Co_{0.15}Al_{0.03}O₂.

(Production of Positive Electrode Plate)

The following materials were mixed: 100 parts by mass LiNi_{0.82}Co_{0.15}Al_{0.03}O₂, which was a positive electrode active material; 1 part by mass acetylene black, which was a conducting agent; and 0.9 parts by mass polyvinylidene fluoride (PVDF), which was a binder. This mixture was placed in N-methyl-2-pyrrolidone (NMP) serving as a dispersion medium, and the dispersion was kneaded to prepare a positive electrode mixture slurry. This positive electrode mixture slurry was applied by a doctor blade method to both sides of a positive electrode current collector made of aluminum and having a thickness of 15 μm. The positive electrode mixture slurry was dried to form a positive electrode mixture layer 33. In this process, a positive electrode current collector exposed portion 34 was provided at a position corresponding to a center portion of the completed positive electrode plate 31. In the portion 34, the positive electrode mixture layer 33 was not formed on either side of the positive electrode plate 31. The positive electrode mixture layer 33 was compressed with a roller and the compressed electrode plate was cut in a predetermined size. Finally, a positive electrode tab 32 made of aluminum was connected to the positive electrode current collector exposed portion 34 to produce a positive electrode plate 31 illustrated in FIG. 3.

(Production of Electrode Body)

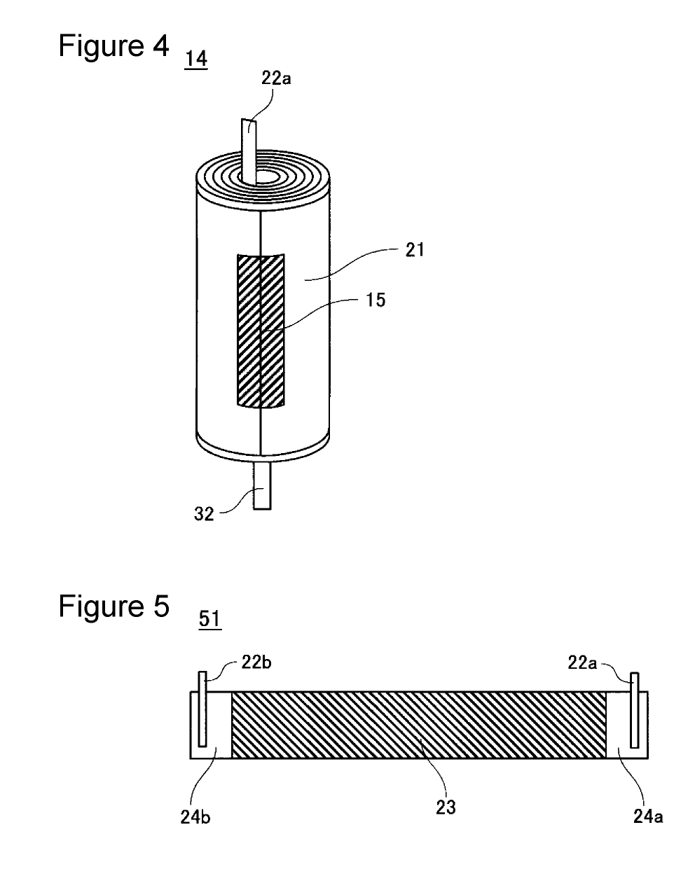

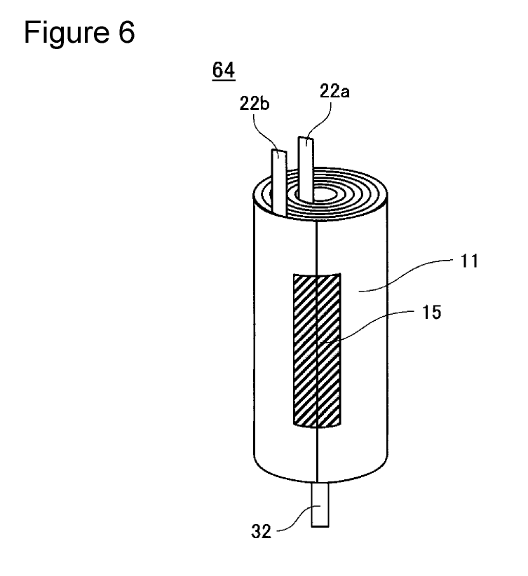

The negative electrode plate 21 and the positive electrode plate 31 produced as described above were wound with a separator 11 formed of a microporous polyethylene membrane interposed therebetween to produce an electrode body 14. At this time, the first negative electrode current collector exposed portion 24a was located on the winding start side of the electrode body 14. The second negative electrode current collector exposed portion 24b was located so as to occupy the entire outermost surface of the electrode body 14. A winding holding tape 15 made of polypropylene and having a thickness of 30 μm was pasted on the winding finish end of the negative electrode plate 21 as illustrated in FIG. 4.

(Production of Non-Aqueous Electrolyte)

A non-aqueous solvent was prepared by mixing ethylene carbonate (EC), ethyl methyl carbonate (EMC), and dimethyl carbonate (DMC) in a volume ratio of 25:5:70 (1 atm, 25° C.). In this non-aqueous solvent, 1.4 mol/L of lithium hexafluorophosphate (LiPF₆), an electrolyte salt, was dissolved to prepare a non-aqueous electrolyte.

(Production of Non-Aqueous Electrolyte Secondary Battery)

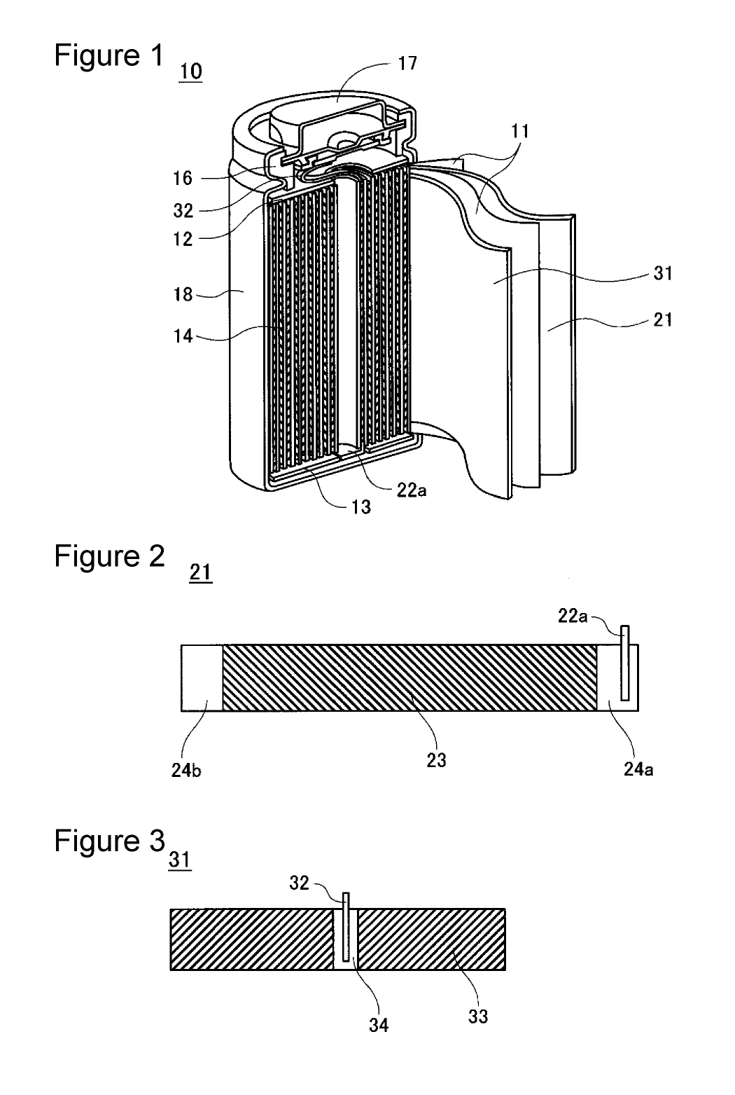

An upper insulating plate 12 and a lower insulating plate 13 were disposed on the top and the bottom of the electrode body 14, respectively. Next, the negative electrode tab 22a was bent toward the center of the electrode body 14, and the electrode body 14 was placed in an outer can 18. The negative electrode tab 22a was welded to the bottom of the outer can 18 by resistance welding using a pair of electrodes. The positive electrode tab 32 was connected to the terminal plate of a sealing body 17. The non-aqueous electrolyte was injected into the outer can 18, and the sealing body 17 was then fixed in the opening of the outer can 18 with a gasket 16 therebetween under pressure to produce a non-aqueous electrolyte secondary battery 10 having a diameter of 18 mm and a height of 65 mm illustrated in FIG. 1.

### Examples 2 to 7

Non-aqueous electrolyte secondary batteries 10 in Examples 2 to 7 were produced in the same manner as in Example 1 except that the amount of SiO in the negative electrode active material was changed to the amounts shown in Table 1.

### Example 8

A non-aqueous electrolyte secondary battery 10 in Example 8 was produced in the same manner as in Example 2 except that silicon (Si) was used instead of SiO coated with carbon.

### Examples 9 to 14

Non-aqueous electrolyte secondary batteries 10 in Examples 9 to 14 were produced in the same manner as in Example 8 except that the amount of Si in the negative electrode active material was changed to the amounts shown in Table 1.

### Example 15

(Production of Silicon-Graphite Composite)

In a nitrogen gas atmosphere, a silicon-containing slurry was produced by placing monocrystalline Si particles together with a bead mill in methylnaphthalene solvent and wet-milling the Si particles so as to obtain a mean particle size (median size D50) of 0.2 m. Graphite particles and carbon pitch were added to the silicon-containing slurry and mixed to carbonize carbon pitch. The product was classified so as to obtain a particle size in a predetermined range, and carbon pitch was added to the obtained product. The carbon pitch was carbonized to produce a silicon-graphite composite in which Si particles and graphite particles were bonded to each other with amorphous carbon. The amount of silicon in this composite was 20.9% by mass.

A non-aqueous electrolyte secondary battery 10 in Example 15 was produced in the same manner as in Example 1 except that the silicon-graphite composite produced as described above was used instead of SiO coated with carbon.

### Example 16

(Production of Silicon-Lithium Silicate Composite)

In an inert atmosphere, Si particles and lithium silicate (Li₂SiO₃) particles were mixed in a mass ratio of 42:58, and the mixture was milled with a planetary ball mill. The particles obtained by performing milling in an inert gas atmosphere were taken out and heated at 600° C. for 4 hours in an inert gas atmosphere. The heated particles (hereinafter referred to as base particles) were ground and mixed with coal pitch. The mixture was heated at 800° C. for 5 hours in an inert atmosphere so that an electrically conductive layer containing carbon was formed on the surfaces of the base particles. The amount of carbon in the electrically conductive layer was 5% by mass relative to the total mass of the base particles and the electrically conductive layer. Finally, the base particles were classified to prepare a silicon-lithium silicate composite having a mean particle size of 5 μm.

(Analysis of Silicon-Lithium Silicate Composite)

The cross section of the silicon-lithium silicate composite was observed with a scanning electron microscope (SEM). As a result, the mean particle size of Si particles in the composite was less than 100 nm. It was also found that the Si particles were uniformly dispersed in a matrix formed of Li₂SiO₃. The XRD pattern of the silicon-lithium silicate composite was found to have diffraction peaks attributed to Si and Li₂SiO₃. The half width of the index of crystal plane (111) of Li₂SiO₃ appearing near 20=270 in the X-ray diffraction (XRD) pattern was 0.233. The diffraction peak attributed to SiO₂ was not found in the XRD pattern, and the amount of SiO₂ determined by Si-NMR was below the lower limit of detection.

A non-aqueous electrolyte secondary battery 10 in Example 16 was produced in the same manner as in Example 1 except that the silicon-lithium silicate composite produced as described above was used instead of SiO coated with carbon.

### Comparative Example 1

A non-aqueous electrolyte secondary battery in Comparative Example 1 was produced in the same manner as in Example 1 except that only graphite was used as a negative electrode active material.

### Comparative Example 2

A non-aqueous electrolyte secondary battery in Comparative Example 2 was produced in the same manner as in Example 1 except that an electrode body 64 whose outermost surface was covered with a separator 11 was produced by using a negative electrode plate 51 in which a negative electrode tab 22b was connected to a second negative electrode current collector exposed portion 24b, and two negative electrode tabs 22a and 22b were welded to the bottom of an outer can 18.

### Comparative Example 3

A non-aqueous electrolyte secondary battery in Comparative Example 3 was produced in the same manner as in Example 11 except that an electrode body 64 whose outermost surface was covered with a separator 11 was produced by using a negative electrode plate 51 in which a negative electrode tab 22b was connected to a second negative electrode current collector exposed portion 24b, and two negative electrode tabs 22a and 22b were welded to the bottom of an outer can 18.

(Evaluation of Discharge Load Characteristic)

The batteries in Examples 1 to 16 and Comparative Examples 1 to 3 were evaluated for their discharge load characteristics under the following conditions. First, each battery was charged to 4.2 V at a constant current of 0.5 It and charged at a constant voltage of 4.2 V until the current value reached 0.02 It. After a 20-minute pause, each battery was discharged at a constant current of 0.2 It until the battery voltage reached 2.5 V, such that the 0.2 It discharge capacity was determined. Next, each battery was charged under the same conditions as those of the charging method described above, and then each battery was discharged at a constant current of lit until the battery voltage reached 2.5 V, such that the lit discharge capacity was determined. The percentage of the lit discharge capacity relative to the 0.2 It discharge capacity was calculated as a discharge load characteristic. The results are shown in Table 1.

TABLE 1

| | | Amount of | Position of | |
|---|---|---|---|---|
| | | silicon | negative | Discharge |
| | | material | electrode | load |
| | Silicon material | (% by mass) | tab | characteristic |
| Example 1 | SiO | 4 | winding start | 99.4% |
| Example 2 | SiO | 1 | winding start | 96.9% |
| Example 3 | SiO | 2 | winding start | 98.8% |
| Example 4 | SiO | 3 | winding start | 99.4% |
| Example 5 | SiO | 5 | winding start | 99.2% |
| Example 6 | SiO | 7 | winding start | 99.5% |
| Example 7 | SiO | 10 | winding start | 99.4% |
| Example 8 | Si | 1 | winding start | 96.9% |
| Example 9 | Si | 2 | winding start | 98.9% |
| Example 10 | Si | 3 | winding start | 99.3% |
| Example 11 | Si | 4 | winding start | 99.4% |
| Example 12 | Si | 5 | winding start | 99.3% |
| Example 13 | Si | 7 | winding start | 99.4% |
| Example 14 | Si | 10 | winding start | 99.3% |
| Example 15 | Si—C | 4 | winding start | 99.4% |
| | composite | | | |
| Example 16 | Si—Li₂SiO₃ | 4 | winding start | 99.5% |
| | composite | | | |
| Comparative | none | 0 | winding start | 96.5% |
| Example 1 | | | | |
| Comparative | SiO | 4 | winding | 99.4% |
| Example 2 | | | start/winding | |
| | | | finish | |
| Comparative | Si | 4 | winding | 99.4% |
| Example 3 | | | start/winding | |
| | | | finish | |

Table 1 shows that the discharge load characteristic of Example 1 is 99.4%, which is higher than that of Comparative Example 1. The discharge load characteristic of Example 1 is equal to that of Comparative Example 2 in which a negative electrode tab is connected to each of the first and second negative electrode current collector exposed portions of the negative electrode plate. This result suggests that the energizing function obtained by contact between the second negative electrode current collector exposed portion and the outer can in Example 1 exhibits the same effect as that exhibited by the energizing function obtained by connection between the negative electrode tab and the outer can.

The aforementioned effect found in Example 1 may be obtained by using, as a negative electrode active material, SiO which undergoes large expansion during charging. However, an improved discharge load characteristic indicates that sufficient contact between the negative electrode current collector and the outer can is ensured even at the final stage of discharge at which the negative electrode active material shrinks. Since the negative electrode active material undergoes large expansion during charging, the aforementioned effect is above the range of expectations.

Comparison of the amount of SiO between Example 2 and Comparative Example 1 suggests that the discharge load characteristic is improved even at 1% by mass SiO. A small amount of SiO is still expected to improve the discharge load characteristic. It is thus not necessary to set the lower limit of the amount of SiO. Since the discharge load characteristic similar to that of Comparative Example 2 in which two negative electrode tabs are connected to the negative electrode plate is obtained at 3% by mass or more SiO, the amount of SiO is preferably 3% by mass or more.

The results of Examples 8 to 14 and Comparative Example 3 indicate that the use of Si instead of SiO as a silicon material still exhibits the effect similar to that described above. In other words, any silicon material that contains Si and can reversibly intercalate and deintercalate lithium ions is expected to exert the advantageous effects of the present invention.

The results of Examples 15 and 16 indicate that the use of the silicon-graphite composite or the silicon-lithium silicate composite instead of SiO as a silicon material still provides the advantageous effects of the present invention.

In light of the results of Examples and Comparative Examples described above, the embodiments of the present invention will be described below in detail.

In Examples described below, both the first and second negative electrode current collector exposed portions are disposed on each side of the negative electrode plate. When the negative electrode current collector exposed portions are disposed on each side of the negative electrode plate in this way, the negative electrode current collector exposed portions in the longitudinal direction of the negative electrode plate may have a different length on each side. For example, the first negative electrode current collector exposed portion may be provided so as to have a longer length on the inner side, which can reduce the area of the negative electrode mixture layer that does not contribute to charging and discharging. Since a negative electrode tab is not connected to the second negative electrode current collector exposed portion, the second negative electrode current collector exposed portion may be provided only on the outer side of the negative electrode plate that faces the inner wall surface of the outer can.

The length of the first negative electrode current collector exposed portion in the longitudinal direction of the negative electrode plate can be set so as to ensure the region to which a negative electrode tab is to be connected and prevent an excessive decrease in the battery capacity. The length of the first negative electrode current collector exposed portion is preferably set in the range of 3 mm or more and 30 mm or less.

The length of the second negative electrode current collector exposed portion in the longitudinal direction of the negative electrode plate can be set so as to ensure sufficient contact between the second negative electrode current collector exposed portion and the inner wall surface of the outer can. The length of the second negative electrode current collector exposed portion is preferably set such that the second negative electrode current collector exposed portion occupies 30% or more of the outside area of the outermost surface of the negative electrode plate.

A silicon material and graphite are used as negative electrode active materials. These negative electrode active materials are preferably in the form of particles. The mean particle sizes of these materials are preferably 5 μm or more and 30 μm or less.

Since silicon materials have lower electron conductivity than graphite, the surface of the silicon material is preferably coated with carbon as described in Examples. The amount of carbon that covers the surface of the silicon material is preferably 0.1% by mass or more and 10% by mass or less relative to the amount of the silicon material. However, the surface of the silicon material is not necessarily coated with carbon, and the advantageous effects of the present invention are obtained sufficiently even without coating of carbon. The mass of the silicon material does not include the mass of carbon that covers the surface of the silicon material.

The amount of the silicon material in the negative electrode active material is preferably, but not necessarily, 3% by mass or more relative to the total mass of the silicon material and the graphite. The silicon material present in an amount of 3% by mass or more can improve the load characteristic of the non-aqueous electrolyte secondary battery. In consideration of the balance with other battery characteristics such as cycle characteristics, the amount of the silicon material is preferably 20% by mass or less, more preferably 10% by mass or less relative to the total mass of the silicon material and the graphite.

Silicon oxide can be used as a silicon material. In consideration of the balance with other battery characteristics such as cycle characteristics, silicon oxide represented by general formula SiOₓ (0.5≦x<1.6) is preferably used.

As a silicon material, silicon can be used alone or used as a composite with other materials. Silicon may be any one of monocrystalline silicon, polycrystalline silicon, and amorphous silicon. Polycrystalline silicon and amorphous silicon whose crystallite size is 60 nm or less are preferred. The use of such silicon prevents or reduces, for example, particle fracture during charging and discharging to improve cycle characteristics. The mean particle size (median size D50) of silicon is preferably 0.1 μm or more and 10 μm or less, more preferably 0.1 μm or more and 5 μm or less. Examples of the method for obtaining silicon having such a mean particle size include dry milling using a jet mill or a ball mill and wet milling using a bead mill or a ball mill. Silicon can also be alloyed with at least one metal element selected from the group consisting of nickel, copper, cobalt, chromium, iron, silver, titanium, molybdenum, and tungsten.

Materials for forming a composite with silicon are preferably materials having a function of moderating a large change in the volume of silicon with charging and discharging. Examples of such materials include graphite and lithium silicate.

In a silicon-graphite composite, silicon particles and graphite particles are preferably bonded to each other with amorphous carbon as described in Example 8. Graphite may be either artificial graphite or natural graphite. Examples of precursors of amorphous carbon for binding silicon particles and graphite particles include pitch materials, tar materials, and resin materials. Examples of resin materials include vinyl resins, cellulose resins, and phenolic resins. These amorphous carbon precursors can be changed into amorphous carbon by performing heating at 700° C. to 1300° C. in an inert gas atmosphere. When amorphous carbon binds silicon particles and graphite particles in this way, amorphous carbon is one of components of the silicon-graphite composite. The amount of silicon in the silicon-graphite composite is preferably 10% by mass or more and 60% by mass or less.

The silicon-lithium silicate composite preferably has a structure in which silicon particles are dispersed in the lithium silicate phase as described in Example 16. The amount of silicon in the silicon-lithium silicate composite is preferably 40% by mass or more and 60% by mass or less.

SiOₓ has a microscopic structure in which Si particles are dispersed in the SiO₂ phase. This SiO₂ may have a function of moderating expansion and shrinkage of Si during charging and discharging. When SiOₓ is used in the negative electrode active material, however, SiO₂ reacts with lithium (Li) during charging as described in Formula (1).

2SiO₂+8Li⁺+8e⁻→Li₄Si+Li₄SiO₄ (1)

Li₄SiO₄ formed by the reaction between SiO₂ and Li cannot reversibly intercalate and deintercalate lithium. Thus, the negative electrode containing SiOₓ as a negative electrode active material causes accumulation of the irreversible capacity associated with formation of Li₄SiO₄ at initial charging. In contrast, lithium silicate does not undergo a chemical reaction involving accumulation of the irreversible capacity unlike SiOₓ and can accordingly moderate a change in the volume of Si during charging and discharging without reducing the initial charge-discharge efficiency of the negative electrode.

Lithium silicate is not limited to Li₂SiO₃ described in Example 14 and may be lithium silicate represented by general formula Li_{2z}SiO_{2+z}) (0<z<2). The half width of the diffraction peak attributed to the (111) face of lithium silicate in the XRD pattern is preferably 0.050 or larger. This further improves the lithium ion conductivity in the silicon-lithium silicate composite particles and/or the effect of moderating a change in the volume of Si.

Graphite may be either artificial graphite or natural graphite. These may be used alone or in combination.

As the positive electrode active material, any material that can reversibly intercalate and deintercalate lithium ions can be appropriately selected and used. Examples of the positive electrode active material include lithium-transition metal composite oxides represented by LiMO₂ (M represents at least one of Co, Ni, and Mn), LiMn₂O₄, and LiFePO₄. These may be used alone or in combination of two or more. These positive electrode active materials may be used after addition of at least one of zirconium, magnesium, aluminum, and titanium or substitution with a transition metal element.

As a separator, a microporous membrane containing, as a main component, a polyolefin, such as polyethylene (PE) or polypropylene (PP), can be used. A single layer of microporous membrane may be used or two or more layers of microporous membranes may be used. A multilayer separator preferably includes an intermediate layer formed of a layer mainly composed of polyethylene (PE) having a low melting point and a surface layer composed of polypropylene (PP) having high oxidation resistance. Furthermore, inorganic particles made of, for example, aluminum oxide (Al₂O₃), titanium oxide (TiO₂), or silicon oxide (SiO₂) may be added to the separator. These inorganic particles may be contained in the separator or may be applied to the surface of the separator together with a binder. An aramid-based resin may be applied to the surface of the separator.

In the present invention, the negative electrode plate is located on the outermost surface of the electrode body in order to make contact between the second negative electrode current collector exposed portion and the inner wall surface of the outer can. The negative electrode plate preferably occupies the entire outermost surface of the electrode body, but the present invention is not limited to this structure. For example, a winding holding tape can be pasted on the winding finish end of the negative electrode plate unless the winding holding tape hinders contact between the second negative electrode current collector exposed portion and the inner wall surface of the outer can. The region in which the winding holding tape is pasted is preferably set such that the area of the second negative electrode current collector exposed portion that directly faces the inner wall surface of the outer can is equal to or more than 30% of the outside area of the outermost surface of the negative electrode plate. The thickness of the winding holding tape can be selected so as to obtain contact between the second negative electrode current collector exposed portion and the inner wall surface of the outer can. The thickness of the winding holding tape is preferably 50 μm or less, more preferably 30 μm or less.

A non-aqueous electrolyte containing a lithium salt, or an electrolyte salt, dissolved in a non-aqueous solvent can be used. A non-aqueous electrolyte containing a gel polymer instead of a non-aqueous solvent or together with a non-aqueous solvent can also be used.

Examples of the non-aqueous solvent include cyclic carbonates, chain carbonates, cyclic carboxylates, and chain carboxylates. These non-aqueous solvents are preferably used as a mixture of two or more. Examples of cyclic carbonates include ethylene carbonate (EC), propylene carbonate (PC), and butylene carbonate (BC). Cyclic carbonates, such as fluoroethylene carbonate (FEC), in which some of hydrogen atoms are substituted with fluorine atoms can also be used. Examples of chain carbonates include dimethyl carbonate (DMC), ethyl methyl carbonate (EMC), diethyl carbonate (DEC), and methyl propyl carbonate (MPC). Examples of cyclic carboxylates include γ-butyrolactone (γ-BL) and γ-valerolactone (γ-VL). Examples of chain carboxylates include methyl pivalate, ethyl pivalate, methyl isobutyrate, and methyl propionate.

Examples of lithium salts include LiPF₆, LiBF₄, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, LiAsF₆, LiClO₄, Li₂B₁₀Cl₁₀, and Li₂B₁₂Cl₁₂. Among these lithium salts, LiPF₆ is particularly preferred, and the concentration of LiPF₆ in the non-aqueous electrolyte is preferably 0.5 to 2.0 mol/L. LiPF₆ may be mixed with another lithium salt, such as LiBF₄.

### INDUSTRIAL APPLICABILITY

According to the present invention, a non-aqueous electrolyte secondary battery having a high capacity and good output characteristics can be provided. The present invention can be used in a wide range of industrial applications.

### REFERENCE SIGNS LIST

10 Non-aqueous electrolyte secondary battery
11 Separator
14 Electrode body
17 Sealing body
18 Outer can
21 Negative electrode plate
22a Negative electrode tab
23 Negative electrode mixture layer
24a First negative electrode current collector exposed portion
24b Second negative electrode current collector exposed portion
31 Positive electrode plate

1. A non-aqueous electrolyte secondary battery comprising: an electrode body formed by winding a negative electrode plate and a positive electrode plate with a separator interposed therebetween; a non-aqueous electrolyte; an outer can that houses the electrode body and the non-aqueous electrolyte; and a sealing body that seals an opening of the outer can, wherein
the negative electrode plate has a negative electrode mixture layer formed on a negative electrode current collector,
the negative electrode mixture layer contains a silicon material and graphite as negative electrode active materials,
the negative electrode plate has, at its winding start end, a first negative electrode current collector exposed portion to which a negative electrode tab is connected, and the negative electrode plate has, at its winding finish end, a second negative electrode current collector exposed portion in contact with an inner wall surface of the outer can.

2. The non-aqueous electrolyte secondary battery according to claim 1, wherein the silicon material is silicon oxide represented by general formula SiOₓ (0.5≦x<1.6).

3. The non-aqueous electrolyte secondary battery according to claim 1, wherein the silicon material is a composite in which silicon particles and graphite particles are bonded to each other with amorphous carbon.

4. The non-aqueous electrolyte secondary battery according to claim 1, wherein the silicon material is a composite in which silicon particles are dispersed in a lithium silicate phase represented by general formula Li_{2z}SiO_{(2+z)} (0<z<2).

5. The non-aqueous electrolyte secondary battery according to claim 1, wherein an amount of the silicon material is 3% by mass or more and 20% by mass or less relative to a total mass of the silicon material and the graphite.
